(19) United States
(12) Patent Application Publication
(10) Pub. No.: US 2008/0313136 A1
(43) Pub. Date: Dec. 18, 2008

(54) METHOD AND APPARATUS FOR PRODUCING UP-TO-DATE QUERY RESULTS FROM TABLES INCLUDING DATA FROM A DATA WAREHOUSE

(75) Inventor: Guogen ZHANG, San Jose, CA (US)

Correspondence Address: Delizio Gilliam, PLLC (IBM SVL), 15201 Mason Road, Suite 1000-312, Cypress, TX, 77433, US

(73) Assignee: International Business Machines Corporation, Armonk, NY (US)

(21) Appl. No.: 11/848,164

(22) Filed: Aug. 30, 2007

Related U.S. Application Data
(60) Provisional application No. 60/943,814, filed on Jun. 13, 2007.

(51) Int. Cl. G06F 17/30

(52) U.S. Cl. 707/2; 707/E17.017

(57) ABSTRACT

Methods, systems, and computer program products for answering a query to be executed on a database comprising a first table and a second table, and in which the second table includes data from the first table. In one implementation, the method includes refreshing the data in the second table with corresponding data in the first table at a first time, receiving a first query on the first table at a second time that is subsequent to the first time, rewriting the first query into a second query on the first table and a third query on the second table, and executing the second query and the third query respectively on the first table and the second table to generate results for the first query.

### CROSS-REFERENCE TO RELATED APPLICATIONS

This application claims the benefit of U.S. Provisional Application No. 60/943,814, filed Jun. 13, 2007.

### FIELD OF THE INVENTION

The present invention relates generally to data processing, and more particularly to techniques for performing a query on a table including data from a data warehouse.

### BACKGROUND OF THE INVENTION

A data warehouse is a main repository of an organization's historical data—e.g., data concerning items sold. A data warehouse typically includes a base fact table in which historical data is stored. Queries on data contained in a data warehouse are typically performed on one or more summary tables that have a reduced data volume relative to a base fact table. A conventional technique for producing up-to-date query results using summary tables is to maintain the summary tables using an immediate refresh as data is updated (e.g., added, modified, or deleted) within the base fact table so that the data within the summary tables is synchronized with the data contained in the base fact table. However, performing immediate refreshes on summary tables generally causes a significant slow-down in data warehouse maintenance and overall system performance.

### BRIEF SUMMARY OF THE INVENTION

In general, this specification describes methods, systems, and computer program products for answering a query to be executed on a database comprising a first table and a second table, and in which the second table includes data from the first table. In one implementation, the method includes refreshing the data in the second table with corresponding data in the first table at a first time, receiving a first query on the first table at a second time that is subsequent to the first time, rewriting the first query into a second query on the first table and a third query on the second table, and executing the second query and the third query respectively on the first table and the second table to generate results for the first query.

Implementations can include one or more of the following features. The second query on the first table can comprise a query only on data in the first table that has been updated during a time between the first time and the second time. The second query on the first table can include predicates on time columns within the first table. The first table can be a base fact table associated with a data warehouse, and the second table can be a summary table including data from the base fact table. Results of the second query and the third query can be combined to form the results of the first query.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a block diagram of a data processing system in accordance with one implementation.

FIG. 2 illustrates one implementation of a method for generating a query on a summary table and a base fact table.

FIG. 3 illustrates an example base table schema.

FIG. 4 is a block diagram of a data processing system suitable for producing up-to-date query results through use of a summary table in accordance with one implementation.

Like reference symbols in the various drawings indicate like elements.

### DETAILED DESCRIPTION OF THE INVENTION

The present invention relates generally to data processing, and more particularly to techniques for performing a query on a table including data from a data warehouse. The following description is presented to enable one of ordinary skill in the art to make and use the invention and is provided in the context of a patent application and its requirements. The present invention is not intended to be limited to the implementations shown but is to be accorded the widest scope consistent with the principles and features described herein.

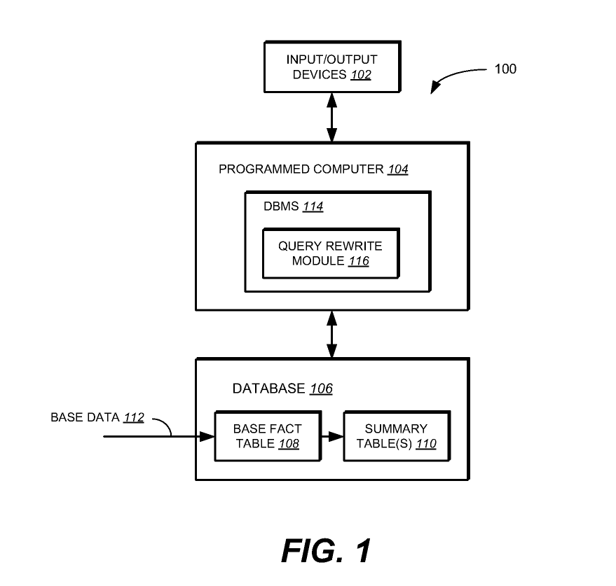

FIG. 1 illustrates a data processing system 100 in accordance with one implementation of the invention. The data processing system 100 can comprise the IBM DB2 Data Warehouse Edition (DWE) product available from International Business Machines Corporation of Armonk, N.Y. Data processing system 100 includes input and output devices 102, a programmed computer 104, and a storage device 106 (e.g., a database). Input and output devices 102 can include devices such as a printer, a keyboard, a mouse, a digitizing pen, a display, a printer, and the like. Programmed computer 104 can be any type of computer system, including for example, a workstation, a desktop computer, a laptop computer, a personal digital assistant (PDA), a cell phone, a network, and so on. In one implementation, the storage device 106 includes a base fact table 108 and one or more summary tables 110. Depending on the design of the schema, the base fact table could be more than one table. In one implementation, the base fact table 108 is a repository of an organization's historical data and is updated with base data 112. The one or more summary tables 110 include data from the base fact table 108.

Running on the programmed computer 104 is a database management system (DBMS) 114. In one implementation, the database management system 114 includes a query rewrite module 116 configured to generate a query on each of one or more summary tables 110 and the base fact table 108 such that up-to-date query results are produced from the query (as described in greater detail below).

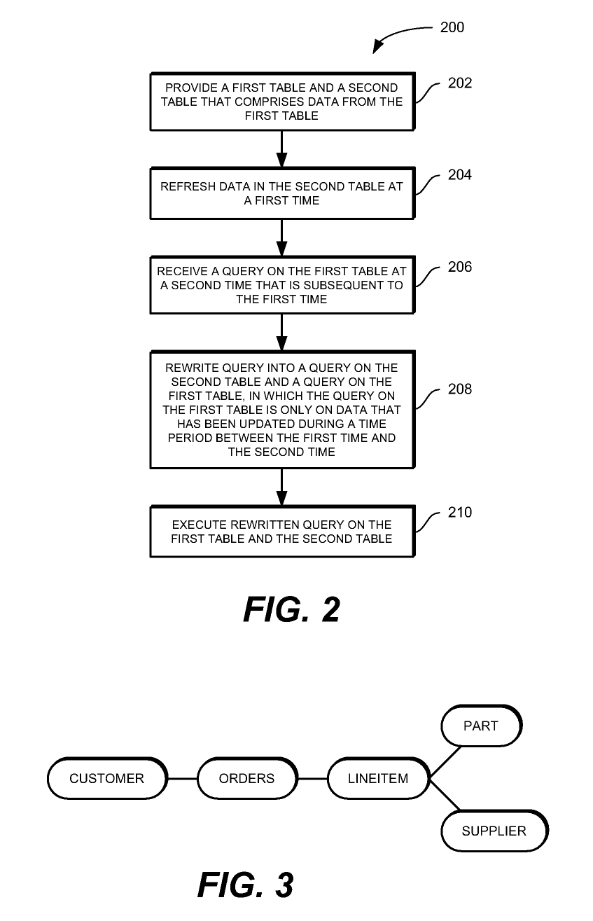

FIG. 2 is a flow diagram illustrating one implementation of a computer-implemented method 200 for generating a query on a summary table and a base fact table that produces up-to-date query results. The method 200 begins with providing a first table, and a second table that includes data from the first table (step 202). In one implementation, the first table is a base fact table (e.g., base fact table 108) and the second table is a summary table (e.g., a summary table 110). In one implementation, data within the first table is continually updated—e.g., data is added, modified, or deleted. Data in the second table is refreshed with data in the first table at a first time (e.g., by database management system 114) (step 204). In one implementation, the data in the second table is refreshed at pre-determined periods independent of any queries that are performed on the first table. Refreshing the second table permits the data in the second table to be synchronized with corresponding data in the first table. A query on the first table is received at a second time that is subsequent to the first time (step 206). In general, the second time corresponds to a time that occurs in between the pre-determined periods at which data in the second table is refreshed with data in the first table.

The query on the first table is rewritten (e.g., by query rewrite module 116) into a query on the second table and a query on the first table (step 208). In one implementation, the query on the first table is only performed on data that has been updated within the first table during a time period between the first time and the second time. Thus, in one implementation, a query on a base fact table is rewritten into a query on the summary table and a query on the base fact table (unlike a conventional query rewrite system that performs a query only on a refreshed summary table). The rewritten query is executed on the first table and the second table (step 210). The results of the query can be, for example, displayed to a user on an output device (e.g., a display) or be provided to an application.

Typically a data warehouse has time associated with the data. Thus, in one implementation, a query rewrite will use both summarized data and unsummarized data to produce accurate results. In one implementation, the unsummarized data (e.g., corresponding data in the base fact table) is found in by using predicates on user time columns. Therefore, data can come into the data warehouse in any form any time and can reside in any place without restrictions and without extra storage for remembering delta. As long as data comes in roughly time order, and the database design provides efficient time-based search, which are usually the case in a data warehouse system. Data comes into a data warehouse, not always in a strict order. However, in a case in which data does not enter the data warehouse in a strict order—e.g., some new data carries a time that is prior to the point of time for refresh—an immediate refresh can apply. Since such data is typically small in volume, an immediate refresh of such data will not impact system performance.

Other alternatives include maintenance of summary tables with near real-time delay: 1) immediate propagation and deferred apply—in which a delta (of updates to data in the second table) is accumulated, and applied in batches. This technique reduces the overhead of refreshing summary tables, but requires storage of the delta, and cannot achieve up-to-date query results); and 2) using LOAD to place new data in a separate portion of the base fact table, and with a known delta, it is easier to refresh summary tables. However, data in a base fact table is usually partitioned and clustered based on a pre-determined criteria, and therefore placing new data into a separate portion of the base fact table requires a follow-up step to re-organize the data after a refresh of a summary table.

An example of the techniques discussed above will now be described. In the following description we use the following tables from the Transaction Processing Performance Council TPC-H benchmark database as an example. Some relevant columns are listed below for the tables involved. The links between tables (shown in FIG. 3) are for the natural joins with obvious keys, as shown in the following queries. Also assume that the foreign key and primary key relationship among the joined keys hold so we have lossless joins that allow us to have extra tables in the summary table for answering queries.

CUSTOMER (C_CUSTKEY, C_NAME, C_ADDRESS, C_PHONE,
C_ACCTBAL, ...)
ORDERS(O_ORDERKEY, O_CUSTKEY, O_ORDERSTATUS,
O_TOTALPRICE, O_ORDERDATE, ...)
LINEITEM (L_ORDERKEY, L_PARTKEY, L_SUPPKEY,
L_LINENUMBER, L_QUANTITY, L_EXTENDEDPRICE,
L_DISCOUNT, L_TAX, L_SHIPDATE,
L_RECEIPTDATE, ...)
PART (P_PARTKEY, P_NAME, P_MFGR, P_BRAND,
P_RETAILPRICE, ...)
SUPPLIER (S_SUPPKEY, S_NAME, S_ADDRESS, S_PHONE,
S_ACCTBAL, ...)

This database is for operational data store, which is accumulation of operational data, but can be used for some analytics. The design of this database does not use star schema. We apply the principles of multi-dimensional analytics to this database. The techniques proposed here also apply to star schemas. Our focus is to sum the data up at the lowest level of combinations for each CUSTOMER, PART, SUPPLIER, ORDERDATE, and SHIPDATE. For example, a query looks like the following:

```
SELECT C_CUSTKEY, P_PARTKEY, S_SUPPKEY,
O_ORDERDATE, L_SHIPDATE, SUM(L_QUANTITY),
SUM(L_EXTENDEDPRICE), COUNT(*)
FROM CUSTOMER, ORDERS, LINEITEM, PART, SUPPLIER
WHERE C_CUSTKEY = O_CUSTKEY
      AND O_ORDERKEY = L_ORDERKEY
      AND L_PARTKEY = P_PARTKEY
      AND L_SUPPKEY = S_SUPPKEY
GROUP BY C_CUSTKEY, P_PARTKEY, S_SUPPKEY,
O_ORDERDATE, L_SHIPDATE;
```

If we materialize this query into a summary table, then the query can be used to answer many interesting queries, such as the 10 best-selling parts in a certain year, or a certain month, 10 most revenue generating customers in certain period of time, or least revenue generating suppliers, etc. For the data warehouse, we need a policy in keeping the data. The policy is usually based on the date/time. Let's assume for this data warehouse, we will keep the data based on the ORDERDATE for 5 years. Data will come into the data warehouse daily or hourly, depending on the operational arrangement, or even real-time replication from the operational systems. Purge of old expired data will happen in a daily end-day processing, or monthly end-month processing.

Let us assume we decided to have a daily refresh on this summary table, and the data comes in based roughly on sequential order of O_ORDERDATE. The syntax to specify this can look like the following:

```
CREATE SUMMARY TABLE SUMORDER(CUSTKEY, PARTKEY,
SUPPKEY, ORDERDATE, SHIPDATE, QUANTITY, AMOUNT,
COUNT)
AS
SELECT C_CUSTKEY, P_PARTKEY, S_SUPPKEY,
O_ORDERDATE, L_SHIPDATE,
SUM(L_QUANTITY), SUM(L_EXTENDEDPRICE),
COUNT(*)
FROM CUSTOMER, ORDERS, LINEITEM, PART, SUPPLIER
WHERE C_CUSTKEY = O_CUSTKEY
      AND O_ORDERKEY = L_ORDERKEY
      AND L_PARTKEY = P_PARTKEY
      AND L_SUPPKEY = S_SUPPKEY
GROUP BY C_CUSTKEY, P_PARTKEY,
S_SUPPKEY, O_ORDERDATE, L_SHIPDATE
DATA INITIALLY DEFERRED REFRESH DEPENDING
ON ORDERS.O_ORDERDATE;
```

This specifies that delta will be derived based on the ORDERS.O_ORDERDATE. Other time granularity can be used by using functions, such as MONTH on the O_ORDERDATE to provide a different refreshing period. At the refresh time, the statement looks as follows:

REFRESH TABLE SUMORDER FOR ‘2006/12/19’;

A host variable containing a date can be used instead of a constant literal. The following predicate will be used in deriving the delta:

ORDERS.ORDERDATE < ‘2006/12/19’;

When refresh happens at the end of the day, we want all the orders for the day to be in already. However, if the order data comes in with some delay, such as one day, then users can use the date of yesterday for refresh. Another option is to use predicate with less than (<=) for delta determination. So optional keyword can be used before the point of time, such as BEFORE, meaning <, or UPTO, meaning <=. Details about how to achieve accurate query results and how to refresh summary tables are discussed below.

### Query Rewrite to Achieve Up-To-Date Query Results

Now that we have predicates to use to separate summed data from unsummed data. The key to achieve accurate up-to-date query results is to use summary tables (summed data) and also base table delta (unsummed data) to rewrite queries with UNION ALL. For example, we have the following query to list all the parts and their sales amount with sales greater than $500,000 from 2006-10-01 up to today (2006-12-20):

Q1:

```
SELECT P_PARTKEY, P_NAME, SUM(L_EXTENDEDPRICE)
FROM ORDERS, LINEITEM, PART
WHERE O_ORDERKEY = L_ORDERKEY
      AND L_PARTKEY = P_PARTKEY
      AND O_ORDERDATE >= ‘2006-10-01’
GROUP BY P_PARTKEY, P_NAME
HAVING SUM(L_EXTENDEDPRICE) > 500000;
```

Traditional query rewrite will use summary table SUMORDER for this query as follows:

Q2:

SELECT PARTKEY, P_NAME, SUM(AMOUNT)
FROM SUMORDER, PART
WHERE PARTKEY = P_PARTKEY
AND ORDERDATE >= ‘2006-10-01’
GROUP BY PARTKEY, P_NAME
HAVING SUM(AMOUNT) > 500000;

(using our terminology, the tables CUSTOMER and SUPPLIER in SUMORDER are extra tables for the query Q2, and PART is a join-back table).

However, this may not produce the up-to-date result if we refreshed SUMORDER yesterday (<2006-12-19) as all the new orders are not counted after that point. Observe that all the data are divided into two non-overlapping set, one is summed up in the summary table with O_ORDERDATE < ‘2006/12/19’, the other set we can use predicate to find in the base table with O_ORDERDATE >= ‘2006/12/19’. Instead of rewriting the query as Q2, we rewrite the query into the following:

Q3:

```
SELECT PARTKEY, P_NAME, SUM(AMOUNT)
FROM (
      SELECT PARTKEY, P_NAME, SUM(AMOUNT) ----part 1
      FROM SUMORDER, PART
      WHERE PARTKEY = P_PARTKEY
          AND ORDERDATE >= ‘2006-10-01’
      GROUP BY PARTKEY, P_NAME
    UNION ALL
      SELECT P_PARTKEY, P_NAME,
      SUM(L_EXTENDEDPRICE) ---- part 2
      FROM ORDERS, LINEITEM, PART
      WHERE O_ORDERKEY = L_ORDERKEY
          AND L_PARTKEY = P_PARTKEY
          AND O_ORDERDATE >= ‘2006-12-19’
      GROUP BY P_PARTKEY, P_NAME
) AS T(PARTKEY, P_NAME, AMOUNT)
GROUP BY PARTKEY, P_NAME
HAVING SUM(AMOUNT) > 500000;
```

Part 1 of the UNION ALL is from the summary table, and part 2 is from the base data after the point of time used in refresh.

To derive this query, we start from the original query Q1, and match with summary tables using the standard matching logic. And then we discover that the matched summary table only provides summed data up to a certain point (< ‘2006-12-19’ in this example), then we divide the Q1 into a UNION ALL query as follows:

SELECT P_PARTKEY, P_NAME, SUM(L_EXTENDEDPRICE)
FROM

| | |
|---|---|
| ( | SELECT * |
| | FROM ORDERS, LINEITEM, PART |
| | WHERE O_ORDERKEY = L_ORDERKEY |
| | AND L_PARTKEY = P_PARTKEY |
| | AND O_ORDERDATE >= ‘2006-10-01’ |
| | AND O_ORDERDATE < ‘2006-12-19’ |
| | UNION ALL |
| | SELECT * |
| | FROM ORDERS, LINEITEM, PART |
| | WHERE O_ORDERKEY = L_ORDERKEY |
| | AND L_PARTKEY = P_PARTKEY |
| | AND O_ORDERDATE >= ‘2006-12-19’ |

) T
GROUP BY P_PARTKEY, P_NAME
HAVING SUM(L_EXTENDEDPRICE) > 500000;

Applying the UNION ALL distribution rules, we have the following intermediate query:

SELECT PARTKEY, P_NAME, SUM(AMOUNT)
FROM

| | |
|---|---|
| ( | SELECT P_PARTKEY, P_NAME, SUM(L_EXTENDEDPRICE) |
| | FROM ORDERS, LINEITEM, PART |
| | WHERE O_ORDERKEY = L_ORDERKEY |
| | AND L_PARTKEY = P_PARTKEY |
| | AND O_ORDERDATE >= ‘2006-10-01’ |
| | AND O_ORDERDATE < ‘2006-12-19’ |
| | GROUP BY P_PARTKEY, P_NAME |
| | UNION ALL |
| | SELECT P_PARTKEY, P_NAME, |
| | SUM(L_EXTENDEDPRICE) |
| | FROM ORDERS, LINEITEM, PART |
| | WHERE O_ORDERKEY = L_ORDERKEY |
| | AND L_PARTKEY = P_PARTKEY |
| | AND O_ORDERDATE >= ‘2006-12-19’ |

) AS T(PARTKEY, P_NAME, AMOUNT)
GROUP BY PARTKEY, P_NAME
HAVING SUM(AMOUNT) > 500000;

And then rewrite the first branch of the UNION ALL subquery using summary table SUMORDER, we get the rewritten query Q3. Since the unsummed part of data is small in volume (in this case it's one day's worth of base data), the performance will be good.

### Initial Refresh and Deferred Refresh

Initial refresh will be a full refresh, but the syntax will be the same as any other refresh using a point of time for refresh. For example, after creating SUMORDER, we perform the following initial refresh:
REFRESH TABLE SUMORDER FOR ‘2006/12/10’; - - by default, it is for BEFORE
   Since it's the first refresh by checking the last refresh timestamp and last refresh point of time (refresh timestamp and the last refresh point of time are all initialized to 0 or something like ‘1900-01-01’), the database management system will do a full refresh using the following (either INSERT or LOAD):

```
INSERT INTO SUMORDER
SELECT C_CUSTKEY, P_PARTKEY, S_SUPPKEY,
O_ORDERDATE, L_SHIPDATE,
SUM(L_QUANTITY), SUM(L_EXTENDEDPRICE), COUNT(*)
FROM CUSTOMER, ORDERS, LINEITEM, PART, SUPPLIER
WHERE C_CUSTKEY = O_CUSTKEY
      AND O_ORDERKEY = L_ORDERKEY
      AND L_PARTKEY = P_PARTKEY
      AND L_SUPPKEY = S_SUPPKEY
      AND O_ORDERDATE < ‘2006/12/10’
GROUP BY C_CUSTKEY, P_PARTKEY, S_SUPPKEY,
O_ORDERDATE, L_SHIPDATE;
```

The above refresh will also set the refresh timestamp and the refresh point of time. We assume that a daily refresh will be performed afterwards. For the next day, the refresh statement will be as follows:

REFRESH TABLE SUMORDER FOR ‘2006/12/11’; -- by default,
it is for
BEFORE

The summed delta will be determined by the following query by adding two comparisons on O_ORDERDATE using the two points of time for refresh:

```
SELECT C_CUSTKEY, P_PARTKEY, S_SUPPKEY,
O_ORDERDATE, L_SHIPDATE,
SUM(L_QUANTITY), SUM(L_EXTENDEDPRICE), COUNT(*)
FROM CUSTOMER, ORDERS, LINEITEM, PART, SUPPLIER
WHERE C_CUSTKEY = O_CUSTKEY
      AND O_ORDERKEY = L_ORDERKEY
      AND L_PARTKEY = P_PARTKEY
      AND L_SUPPKEY = S_SUPPKEY
      AND O_ORDERDATE >= ‘2006/12/10’
      AND O_ORDERDATE < ‘2006/12/11’
GROUP BY C_CUSTKEY, P_PARTKEY, S_SUPPKEY,
O_ORDERDATE, L_SHIPDATE;
```

And refresh is performed by MERGE as follows (again it can be done by utilities or SQL):

```
MERGE INTO SUMORDER S
USING (
SELECT C_CUSTKEY, P_PARTKEY, S_SUPPKEY,
O_ORDERDATE, L_SHIPDATE,
SUM(L_QUANTITY), SUM(L_EXTENDEDPRICE), COUNT(*)
FROM CUSTOMER, ORDERS, LINEITEM, PART, SUPPLIER
WHERE C_CUSTKEY = O_CUSTKEY
      AND O_ORDERKEY = L_ORDERKEY
      AND L_PARTKEY = P_PARTKEY
      AND L_SUPPKEY = S_SUPPKEY
      AND O_ORDERDATE >= ‘2006/12/10’
      AND O_ORDERDATE < ‘2006/12/11’
GROUP BY C_CUSTKEY, P_PARTKEY, S_SUPPKEY,
O_ORDERDATE, L_SHIPDATE) D(CUSTKEY, PARTKEY,
SUPPKEY, ORDERDATE, SHIPDATE, QTY, AMT, CNT)
ON S.CUSTKEY = D.CUSTKEY AND S.SUPPKEY = D.SUPPKEY
AND S.ORDERDATE = D.ORDERDATE AND
S.SHIPDATE = D.SHIPDATE
WHEN MATCHED THEN
      UPDATE SET S.QUANTITY = S.QUANTITY + D.QTY,
S.AMOUNT = S.AMOUNT + D.AMT, S.COUNT = S.COUNT+D.CNT
WHEN NOT MATCHED THEN
      INSERT VALUES (D.CUSTKEY, D.PARTKEY, D.SUPPKEY,
D.ORDERDATE, D.SHIPDATE, D.QTY, D.AMT, D.CNT) ;
```

All these can be done automatically by the system as implementation for the REFRESH TABLE statement.

### Use Immediate Refresh Delayed Trickling Updates and Batch Delete

There are cases that some data before the last refresh point of time coming in due to delay. In that case, immediate refresh should apply. The immediate refresh can leverage the AFTER trigger mechanism with a predicate on time, and each REFRESH will also modify the trigger condition. For example, after this:

REFRESH TABLE SUMORDER FOR ‘2006/12/11’; -- by default,
it is for
BEFORE

All the data with O_ORDERDATE < ‘2006/12/11’ are summed into the summary table SUMORDER, any data with this condition true will need to trigger an immediate refresh.

Another scenario that requires immediate refresh is update on the non-fact base table without a time associated with them. If these columns are referenced in summary tables, an immediate refresh is performed so the data will not be lost. Yet another scenario is to roll out old data. For example data with O_ORDERDATE <= ‘2000-12-30’ will be purged from active database. It is best to prepare the summary table first, and then remove the base fact data. It can be done by using a new option for REFRESH TABLE statement supplying data deletion point of time:

REFRESH TABLE SUMORDER FOR DELETE UPTO ‘2000-12-30’;

A process that is similar to MERGE (inverse) applies, i.e., do subtraction when MATCHED, and delete if COUNT becomes zero.

### Automating the Refresh Process

Some pre-scheduled tasks can be used to run the above process for periodical refresh by supplying appropriate point of time for refresh for both data insertion and deletion. The period depends on the data volume, and it could be weekly, daily, hourly, etc. And for deletion it could be monthly or quarterly, etc.

An advantage of the techniques described above is that the techniques do not require an extra timestamp or extra storage, and mainly rely on a deferred refresh (which does not impact system performance, and also provides up-to-date query results).

One or more of method steps described above can be performed by one or more programmable processors executing a computer program to perform functions by operating on input data and generating output. Generally, the invention can take the form of an entirely hardware embodiment, an entirely software embodiment or an embodiment containing both hardware and software elements. In one implementation, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

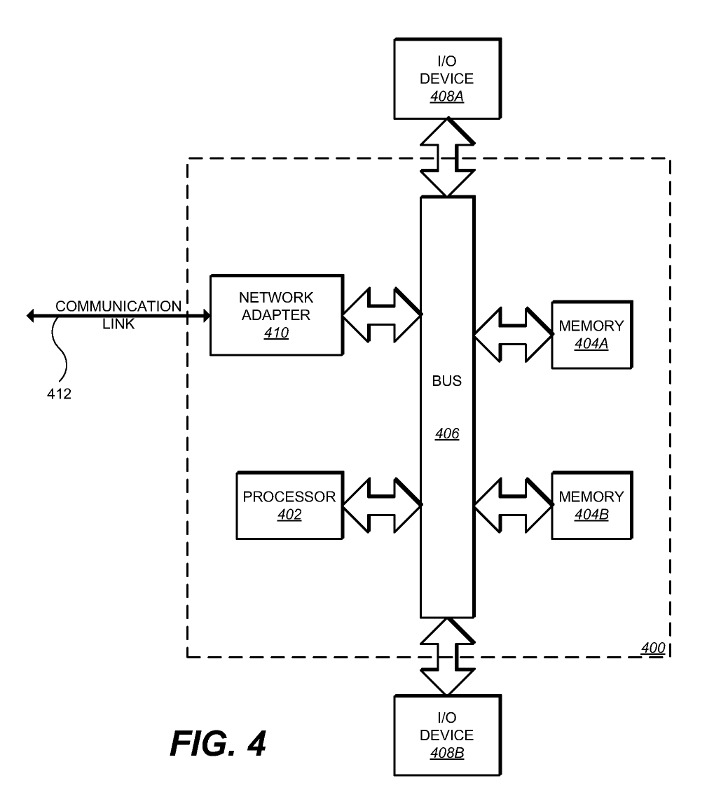

FIG. 4 illustrates a data processing system 400 suitable for storing and/or executing program code. Data processing system 400 includes a processor 402 coupled to memory elements 404A-B through a system bus 406. In other embodiments, data processing system 400 may include more than one processor and each processor may be coupled directly or indirectly to one or more memory elements through a system bus.

Memory elements 404A-B can include local memory employed during actual execution of the program code, bulk storage, and cache memories that provide temporary storage of at least some program code in order to reduce the number of times the code must be retrieved from bulk storage during execution. As shown, input/output or I/O devices 408A-B (including, but not limited to, keyboards, displays, pointing devices, etc.) are coupled to data processing system 400. I/O devices 408A-B may be coupled to data processing system 400 directly or indirectly through intervening I/O controllers (not shown).

In one implementation, a network adapter 410 is coupled to data processing system 400 to enable data processing system 400 to become coupled to other data processing systems or remote printers or storage devices through communication link 412. Communication link 412 can be a private or public network. Modems, cable modems, and Ethernet cards are just a few of the currently available types of network adapters.

Various implementations of a predicate-based mechanism for determining a delta for summary table refresh and a new query rewrite method to produce accurate query result have been described. Nevertheless, various modifications may be made to the implementations described above. For example, steps of the methods discussed above can be performed in a different order and still achieve desirable results. Accordingly, many modifications may be made without departing from the scope of the present invention.

What is claimed is:

1. A computer-implemented method for answering a query to be executed on a database comprising a first table and a second table, the second table including data from the first table, the method comprising:
refreshing the data in the second table with corresponding data in the first table at a first time, the data in the second table being refreshed so that the data in the second table is synchronized with the corresponding data in the first table;
receiving a first query on the first table at a second time that is subsequent to the first time;
rewriting the first query into a second query on the first table and a third query on the second table; and
executing the second query and the third query respectively on the first table and the second table to generate results for the first query.

2. The method of claim 1, wherein the second query on the first table comprises a query only on data in the first table that has been updated during a time between the first time and the second time.

3. The method of claim 2, wherein the second query on the first table includes predicates on time columns within the first table.

4. The method of claim 2, wherein:
the first table is a base fact table associated with a data warehouse; and
the second table is a summary table including data from the base fact table.

5. The method of claim 2, wherein results of the second query and the third query are combined to form the results of the first query.

6. A computer readable medium encoded with a computer program for answering a query to be executed on a database comprising a first table and a second table, the second table including data from the first table, the computer program comprising computer executable instructions for:
refreshing the data in the second table with corresponding data in the first table at a first time, the data in the second table being refreshed so that the data in the second table is synchronized with the corresponding data in the first table;
receiving a first query on the first table at a second time that is subsequent to the first time;
rewriting the first query into a second query on the first table and a third query on the second table; and
executing the second query and the third query respectively on the first table and the second table to generate results for the first query.

7. The computer readable medium of claim 6, wherein the second query on the first table comprises a query only on data in the first table that has been updated during a time between the first time and the second time.

8. The computer readable medium of claim 7, wherein the second query on the first table includes predicates on time columns within the first table.

9. The computer readable medium of claim 7, wherein:
the first table is a base fact table associated with a data warehouse; and
the second table is a summary table including data from the base fact table.

10. The computer readable medium of claim 7, wherein results of the second query and the third query are combined to form the results of the first query.

11. A data processing system comprising:
a database comprising a first table and a second table, the second table including data from the first table; and
a database management system configured to
refresh the data in the second table with corresponding data in the first table at a first time, the data in the second table being refreshed so that the data in the second table is synchronized with the corresponding data in the first table;
receive a first query on the first table at a second time that is subsequent to the first time;
rewrite the first query into a second query on the first table and a third query on the second table; and
execute the second query and the third query respectively on the first table and the second table to generate results for the first query.

12. The data processing system of claim 11, wherein the second query on the first table comprises a query only on data in the first table that has been updated during a time between the first time and the second time.

13. The data processing system of claim 12, wherein the second query on the first table includes predicates on time columns within the first table.

14. The data processing system of claim 12, wherein:
the first table is a base fact table associated with a data warehouse; and
the second table is a summary table including data from the base fact table.

15. The data processing system of claim 12, wherein results of the second query and the third query are combined to form the results of the first query.

16. The data processing system of claim 11, wherein the data processing system comprises an IBM DB2 Data Warehouse Edition (DWE) product.
